(19) United States
(12) Patent Application Publication
(10) Pub. No.: US 2020/0037815 A1
(43) Pub. Date: Feb. 6, 2020

(54) TOASTER OVEN WITH BUILT-IN HOT PLATE

(71) Applicant: Sahara Electronics Ltd., Tel Aviv (IL)

(72) Inventor: Shahram Farhamandfar, Holon (IL)

(73) Assignee: Sahara Electronics Ltd., Tel Aviv (IL)

(21) Appl. No.: 16/052,799

(22) Filed: Aug. 2, 2018

(51) Int. Cl. A47J 37/06; A47J 36/32

(52) U.S. Cl. CPC A47J 37/0629; A47J 36/32

(57) ABSTRACT

A toaster oven includes a compartment with an inner chamber, a heating element associated with the inner chamber for heating food articles placed in the inner chamber, and a controller in electrical communication with the heating element for controlling heating of the food articles. An exterior upper surface of the compartment includes a hot plate for warming food placed thereupon.

### FIELD OF THE INVENTION

The present invention generally relates to toaster ovens and more particularly to a toaster oven with a built-in hot plate.

### BACKGROUND OF THE INVENTION

Electric toaster ovens are well known kitchen appliances that are used to toast bread and cook foods. The toaster oven is useful for making toast, broiling, and reheating or warming leftovers. Such toaster ovens conventionally have a wire form rack for supporting foods in the toaster oven cavity for toasting or cooking.

The toaster oven may be mounted beneath a kitchen cabinet, or alternatively, a toaster oven may be supported on top of a kitchen's countertop. A toaster oven usually has many accessories such as a broil rack, pizza crisper, baking pan, and the like.

All food is prepared inside the toaster oven.

### SUMMARY OF THE INVENTION

The present invention seeks to provide a novel and improved toaster oven which includes an additional external cooking or warming appliance, namely, a built-in hot plate, as described in detail below. In contrast to the prior art, food can be prepared or heated not only in the interior of the toaster oven but also on the exterior of the toaster oven.

There is thus provided in accordance with a non-limiting embodiment of the present invention a toaster oven including a compartment with an inner chamber, a heating element associated with the inner chamber for heating food articles placed in the inner chamber, and a controller in electrical communication with the heating element for controlling heating of the food articles, wherein an exterior upper surface of the compartment includes a hot plate for warming food placed thereupon.

In accordance with a non-limiting embodiment of the invention the hot plate is heated by the heating element that is associated with the inner chamber.

In accordance with a non-limiting embodiment of the invention the hot plate is heated by another heating element different from the heating element that is associated with the inner chamber.

In accordance with a non-limiting embodiment of the invention heating of the hot plate is controlled by the controller.

In accordance with a non-limiting embodiment of the invention heating of the hot plate is controlled by another controller different from the controller.

In accordance with a non-limiting embodiment of the invention a cover is arranged to hide the controller.

In accordance with a non-limiting embodiment of the invention a cover is arranged to hide the other controller for the hot plate.

### BRIEF DESCRIPTION OF THE DRAWINGS

The present invention will be understood and appreciated more fully from the following detailed description, taken in conjunction with the drawings in which:

FIG. 1 is a simplified perspective illustration of a toaster oven, constructed and operative in accordance with a non-limiting embodiment of the present invention.

### DETAILED DESCRIPTION OF EMBODIMENTS

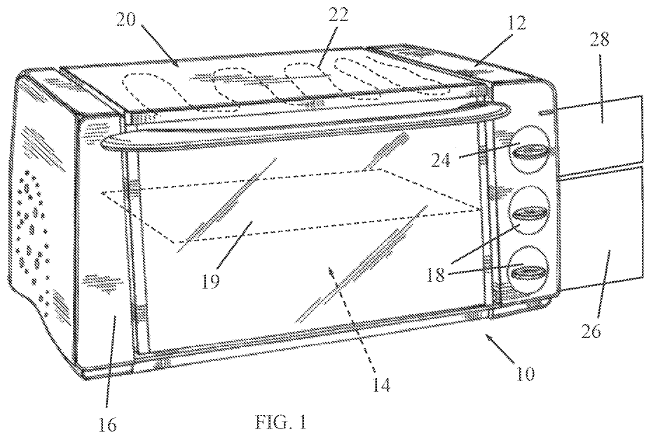

Reference is now made to FIG. 1, which illustrates a toaster oven 10, constructed and operative in accordance with a non-limiting embodiment of the present invention.

The toaster oven 10 includes a compartment 12 with an inner chamber 14. A heating element 16 is associated with the inner chamber 14 for heating food articles placed in the inner chamber 14. A controller 18 is in electrical communication with the heating element 16 for controlling heating of the food articles.

The toaster oven 10 may include one or more trays 19 for placing food thereupon. Alternatively, toaster oven 10 may include more than one compartment 12 and each compartment may have its own dedicated controller.

An exterior upper surface of the compartment 12 (the uppermost compartment in the case of more than one compartment) includes a hot plate 20 for warming food placed thereupon. In one embodiment, hot plate 20 is heated by the same heating element 16 that heats the inner chamber 14. Alternatively, hot plate 20 may be heated by another heating element 22 different from the heating element 16 that is associated with the inner chamber 14.

In one embodiment, heating of the hot plate 20 is controlled by the same controller 18. Alternatively, heating of the hot plate 20 may be controlled by another controller 24 different from the controller 18.

In accordance with a non-limiting embodiment of the invention, a cover 26 is arranged to hide the controller 18. A cover 28 may be arranged to hide the other controller 24 for the hot plate 20. Hiding the controllers may be important as a Sabbath mode of operation.

What is claimed is:

1. An appliance comprising:
a toaster oven comprising a compartment with an inner chamber;
a heating element associated with said inner chamber for heating food articles placed in said inner chamber; and
a controller in electrical communication with said heating element for controlling heating of the food articles;
wherein an exterior upper surface of said compartment comprises a hot plate for warming food placed thereupon.

2. The appliance according to claim 1, wherein said hot plate is heated by said heating element that is associated with said inner chamber.

3. The appliance according to claim 1, wherein said hot plate is heated by another heating element different from said heating element that is associated with said inner chamber.

4. The appliance according to claim 1, wherein heating of said hot plate is controlled by said controller.

5. The appliance according to claim 1, wherein heating of said hot plate is controlled by another controller different from said controller.

6. The appliance according to claim 1, comprising a cover arranged to hide said controller.

7. The appliance according to claim 5, comprising a cover arranged to hide said other controller for said hot plate.
